(19) United States
(12) Patent Application Publication
(10) Pub. No.: US 2021/0295298 A1
(43) Pub. Date: Sep. 23, 2021

(54) METHOD AND SYSTEM FOR REAL-TIME CAUSATION ANALYSIS FOR DETECTING ITEM QUALITY AND QUANTITY ISSUES

(71) Applicant: TOSHIBA TEC KABUSHIKI KAISHA, Tokyo (JP)

(72) Inventors: Krishna PUTHRAN, Bangalore (IN); Megha SAKRIKAR, Bangalore (IN)

(73) Assignee: TOSHIBA TEC KABUSHIKI KAISHA, Tokyo (JP)

(21) Appl. No.: 17/108,740

(22) Filed: Dec. 1, 2020

(30) Foreign Application Priority Data
Mar. 20, 2020 (IN) 202041012050

(51) Int. Cl. G06Q 20/20

(52) U.S. Cl. CPC G06Q 20/208

(57) ABSTRACT

A method and a system are provided for real-time causation analysis for detecting item quality and quantity issues. The method includes receiving current transaction details of one or more items purchased by users from one or more Point of Sale (POS) terminal for a set period, determining at least one of an average of each item from the one or more items, and an association between two or more items from the one or more items purchased for each of the users, comparing the at least one of the average with a first threshold limit and the association with a second threshold limit, and detecting at least one of quality and quantity issues for the one or more items based on the comparison.

### TECHNICAL FIELD

The present subject matter is generally related to causation analysis, more particularly, but not exclusively, to a method and a system for real-time causation analysis for detecting item quality and quantity issues.

### BACKGROUND

In recent years, climate change seemed to have an impact on our environment. With the climate change, resources such as perishable and non-perishable items, which are limited in availability, are becoming scarce. In such a situation, it becomes imperative to regulate item quality and quantity to reduce wastage and to utilize items efficiently. For example, in a store setting, it is quite easy to identify lack of user interest for a regular item at a store, but it is difficult to identify the reason for the lack of interest. So, it becomes difficult to timely rectify the issues related to wastage and utility.

The information disclosed in this background of the disclosure section is for enhancement of understanding of the general background and should not be taken as an acknowledgement or any form of suggestion that this information forms prior art already known to a person skilled in the art.

### BRIEF DESCRIPTION OF DRAWINGS

The accompanying drawings, which are incorporated in and constitute a part of this disclosure, illustrate exemplary embodiments and together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described below, by way of example only, and with reference to the accompanying figures.

FIG. 1 illustrates an exemplary environment for real-time causation analysis for detecting item quality and quantity issues in accordance with some embodiments of the present disclosure.

FIG. 2 shows a detailed block diagram of a causation analysis system in accordance with some embodiments of the present disclosure.

FIG. 3a-FIG. 3b illustrate a flowchart showing a method for real-time causation analysis for detecting item quality and quantity issues in accordance with some embodiments of present disclosure.

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In at least one embodiment, the present disclosure may relate to a method for real-time causation analysis for detecting item quality and quantity issues. The method includes receiving current transaction details of one or more items purchased by users from one or more Point of Sale (POS) terminal for a set period. In the next step, the method includes determining at least one of an average of each item from the one or more items, or an association between two or more items from the one or more items purchased for each of the users. In the subsequent step, the method includes comparing the at least one of the average with a first threshold limit and the association with a second threshold limit. In the final step, the method includes detecting at least one of quality or quantity issues for the one or more items based on the comparison.

In at least one embodiment, the present disclosure may relate to a causation analysis system for real-time causation analysis for detecting item quality and quantity issues. The causation analysis system may include a processor and a memory communicatively coupled to the processor, wherein the memory stores processor-executable instructions, which on execution, cause the processor to receive current transaction details of one or more items purchased by users from one or more Point of Sale (POS) terminal for a set period. In the next step, the causation analysis system determines at least one of an average of each item from the one or more items, or an association between two or more items from the one or more items purchased for each of the users. In the subsequent step, the causation analysis system compares the at least one of the average with a first threshold limit and the association with a second threshold limit. In the final step, the causation analysis system detects at least one of quality or quantity issues for the one or more items based on the comparison.

Furthermore, the present disclosure may relate to a non-transitory computer readable medium including instructions stored thereon that when processed by at least one processor cause a causation analysis system to perform acts of receiving current transaction details of one or more items purchased by users from one or more Point of Sale (POS) terminal for a set period. Thereafter, the instructions cause the at least one processor to determine at least one of an average of each item from the one or more items, and to associate between two or more items from the one or more items purchased for each of the users. Subsequently, the instructions cause the at least one processor to compare the at least one of the average with a first threshold limit or the association with a second threshold limit, and to detect at least one of quality or quantity issues for the one or more items based on the comparison.

The foregoing summary is illustrative only and is not intended to be in any way limiting. In addition to the illustrative aspects, embodiments, and features described above, further aspects, embodiments, and features will become apparent by reference to the drawings and the following detailed description.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration of specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure provide a real-time causation analysis for detecting item quality and quantity issues. The present disclosure captures transaction details from all the POS terminals and analyse the transaction details on a periodic basis. The collected transactions are processed based on either the total number of transactions exceeds a threshold limit or may be processed on fixed time intervals. The transaction details are then processed and the items in each order are analyzed as follows, according to some embodiments.

(a) In a given interval, an anomaly may be detected, such as an average quantity purchased by users per transaction being consistently lower than a threshold limit. For example, an item quantity being sold in the interval per transaction may be much less than the threshold being set by the store. Or the threshold is not reached for example in last 100 transactions. This is an indication of a quality issue as the user is not buying enough of a quantity of an item, as he/she may not be happy with the quality of the item being sold. For example, based on past transaction data, most of the users who buy apples would buy a minimum of 2 kgs per transaction. If, at a given interval, suppose it is observed that the item quantity size in the customer's transaction fell less than 50%, and suppose further that such behavior is observed in many transactions for other users during the same time frame.

(b) In a given interval, in many user transactions, an association rule(s) is broken, which is may have high confidence metrics. For example, one of the association rule having a confidence of 95%, wherein the association between the items such as {Item-1, Item-2}->{Item-3} is broken in a plurality of transactions (e.g., in many transactions). In other words, conditional probability P({Item-3} {Item-1, Item-2})=0.95 is broken in the plurality of transactions. That means the user is buying only item 1 and item 2 and not item 3. However, as per the association rule, item 3 should have been bought by users. The above causation analysis indicates that there is some unexpected behavior in the user buying pattern over the past observed behavior. This observation is strengthened by analyzing individual users' past transactions. For example, suppose that 75% of the user transaction have included the missing items in 90% of the time. This means that at a given period, the item 3 is not selling.

This approach helps to address quantity issue by refilling the store shelf and quality issue by replacing existing items with good quality items (i.e., better quality items). Furthermore, items having quality issues, such as freshness, nearing of an expiry period, etc. may be on discount for encouraging the users to buy more, thereby reducing item wastage.

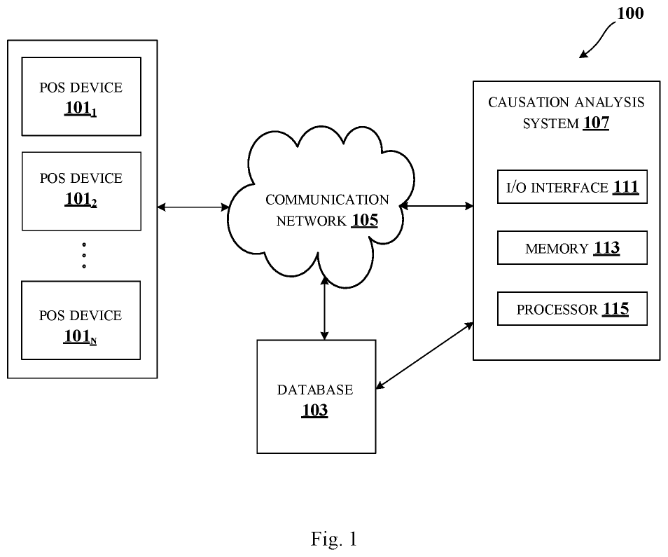

FIG. 1 illustrates an exemplary environment for real-time causation analysis for detecting item quality and quantity issues in accordance with some embodiments of the present disclosure.

As shown in the FIG. 1, the environment 100 includes a POS device 1011, a POS device 1012, . . . , a POS device 101N (collectively referred as plurality of POS devices 101), a database 103, a communication network 105 and a causation analysis system 107. Here, POS refers to a point where one or more retail transactions happen. The plurality of POS devices 101 may be connected through the communication network 105 to the causation analysis system 107. In at least one embodiment, the plurality of POS devices 101 may include, but is not limited to, system comprising at least one of a computer, a printer, display, a barcode scanner, a debit card reader and a credit card reader. The plurality of POS devices 101 may provide current transaction details to the causation analysis system 107 via the communication network 105 and may communicate with the causation analysis system 107 via the communication network 105 for real-time causation analysis. The current transaction details refer to present transaction details of one or more items purchased by users at one of the plurality of POS devices 101. The communication network 105 may include, but is not limited to, a direct interconnection, an e-commerce network, a Peer-to-Peer (P2P) network, Local Area Network (LAN), Wide Area Network (WAN), wireless network (for example, using Wireless Application Protocol), Internet, Wi-Fi, Bluetooth and the like.

In at least one embodiment, the causation analysis system 107 may provide real-time causation analysis for detecting item quality and quantity issues based on current transaction details and past transaction details. The causation analysis system 107 may include an I/O interface 111, a memory 113 and a processor 115. The I/O interface 111 may be configured to receive current transaction details from the plurality of POS devices 101. Analogously, the I/O interface 111 may be configured to communicate with an electronic device (not shown in FIG. 1) to assist a store manager or a store associate in detecting item quality and quantity issues. The electronic device may include, but is not limited to, a mobile terminal, a laptop, a desktop computer and a tablet. The I/O interface 111 may employ communication protocols/methods such as, without limitation, audio, analog, digital, monoaural, Radio Corporation of America (RCA) connector, stereo, IEEE®-1394 high speed serial bus, serial bus, Universal Serial Bus (USB), infrared, Personal System/2 (PS/2) port, Bayonet Neill-Concelman (BNC) connector, coaxial, component, composite, Digital Visual Interface (DVI), High-Definition Multimedia Interface (HDMI®), Radio Frequency (RF) antennas, S-Video, Video Graphics Array (VGA), IEEE® 802.11b/g/n/x, Bluetooth, cellular e.g., Code-Division Multiple Access (CDMA), High-Speed Packet Access (HSPA+), Global System for Mobile communications (GSM®), Long-Term Evolution (LTE®), Worldwide interoperability for Microwave access (WiMax®), or the like.

The current transaction data received by the I/O interface 111 may be stored in the memory 113. The memory 113 may be communicatively coupled to the processor 115 of the causation analysis system 107. The memory 113 may also store processor instructions which may cause the processor 115 to execute the instructions for performing real-time causation analysis for detecting item quality and quantity issues. The 113 may include, without limitation, memory drives, removable disc drives, etc. The memory drives may further include a drum, magnetic disc drive, magneto-optical drive, optical drive, Redundant Array of Independent Discs (RAID), solid-state memory devices, solid-memory state drives, etc.

The processor 115 may include at least one data processor for real-time causation analysis for detecting item quality and quantity issues. The processor 115 may include specialized processing units such as integrated system (bus) controllers, memory management control units, floating point units, graphics processing units, digital signal processing units, etc.

In at least one embodiment, the causation analysis system 107 may exchange data with the database 103 directly or through the communication network 105. The database 103 may be populated or stored with past transaction details that include items purchased, quantity of each item and cost of each item for each user in past. The database may, also, frequently store at least one of average purchase quantity of an item, association rules and user purchase patterns derived from past transaction details by the causation analysis system 107. The past transaction details may refer to data received by the causation analysis system 107 prior to current transaction from one or more plurality of POS devices 101. Here, the association rule refers to data mining procedure that is meant to find frequent patterns, correlations, associations, or causal structures from data sets found in various kinds of databases such as relational databases, transactional databases, and other forms of data repositories. The past transaction details may be used to identify one or more associations between the items purchased by a user based on the association rules.

The database 103 may also be updated at pre-defined intervals of time. These updates may be related to the at least one of items purchased, a quantity of each item and a cost of each item for each user. In addition, the database 103 may be updated with the at least one of an average purchase quantity of an item, association rules and user purchase patterns.

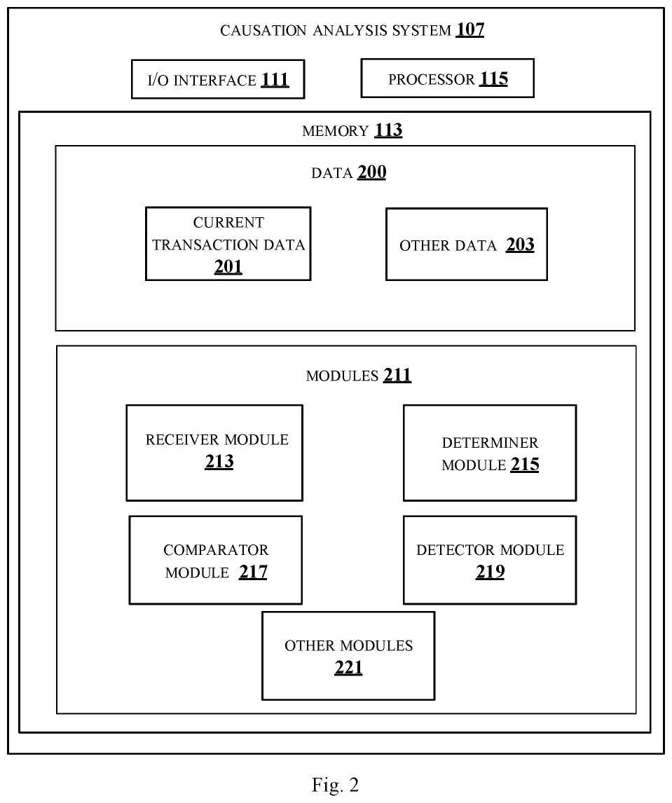

FIG. 2 shows a detailed block diagram of a causation analysis system in accordance with some embodiments of the present disclosure.

The causation analysis system 107, in addition to the I/O interface 111 and processor 115 described above, may include data 200 and one or more modules 211, which are described herein in detail. In at least one embodiment, the data 200 may be stored within the memory 113. The data 200 may include, for example, current transaction data 201 and other data 203.

The current transaction data 201 may include current transaction details of one or more items purchased by users. The current transaction details may include items purchased, quantity of each item and cost of each item for each user in present. The current transaction details received by the causation analysis system 107 from the plurality of POS devices 101 are stored in the current transaction data 201.

The other data 203 may store data, including temporary data and temporary files, generated by one or more modules 211 for performing the various functions of the causation analysis system 107.

In at least one embodiment, the data 200 in the memory 113 are processed by the one or more modules 211 present within the memory 113 of the causation analysis system 107. In at least one embodiment, the one or more modules 211 may be implemented as dedicated hardware units. As used herein, the term module refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality. In some implementations, the one or more modules 211 may be communicatively coupled to the processor 115 for performing one or more functions of the causation analysis system 107. Said modules 211 when configured with the functionality defined in the present disclosure result in novel hardware according to various embodiments.

In one implementation, the one or more modules 211 may include, but are not limited to, a receiver module 213, a determiner module 215, a comparator module 217 and a detector module 219. The one or more modules 211 may, also, include other modules 221 to perform various miscellaneous functionalities of the causation analysis system 107.

The receiver module 213 may receive current transaction details of one or more items purchased by users from one or more POS terminal for a set period. The transaction details may also be referred as order details. The set period may be one of a period based on time and a period based on count of the one or more items. For example, for the period based on time, all the transaction details collected for the last X mins/hours, e.g., a collection of transactions for the last 15 minutes or the last 30 minutes and the like. For the period based on count, the last ‘n’ transactions may be considered, e.g., every 25 transactions or every 50 transactions and the like. The period may be decided by a store.

The determiner module 215 may determine at least one of an average of each item from the one or more items, and association between two or more items from the one or more items purchased for each of the users. For example, the determiner module 215 may fetch the relevant attributes such as items purchased, a quantity of each item and a cost of each item from each transaction and may calculate the average item count for each item for a set period. The average and the association from the current transaction details for a set period are calculated similarly to the average and the association determined from past transaction details for the same set period. The determiner module 215 may calculate and store the average from past transaction details in the database 103. The average may be calculated as follows:

An average purchase quantity of items in the transaction may be given as, for example, average tomatoes per transaction—1 kg, average apples per transaction—1 kg, average milk packets per transaction—2 quantities.

The determiner module 215 may use the average of each item from the past transaction details to calculate a first threshold limit. The first threshold limit may be set by the store. For example, for any given period, the first threshold limit may be set as minimum number of users (in percentage) buying less than minimum threshold quantity of an item, e.g., 60% of the users should buy less than the first threshold limit, according to some embodiments.

All possible association rules for the items in the transaction may be calculated and updated as part of the periodic processing of past transaction details and stored in the database 103. The association may be calculated as follows:

For example: {milk, bread}->eggs i.e. The association rule {Milk, bread}->{Eggs} may mean a user buying milk and bread, buys eggs as well. Similarly, {diapers}->{beer, chips} implies a user buying diapers buys beers and chips as well. And an association {tomato, potato, onion}->{chilies, garlic} implies that a user buying tomato, potato and onion would also buy chilies and garlic as well.

The determiner module 215 may use the association between two or more items from the past transaction details to calculate a second threshold limit. The second threshold limit may be set by the store. For example, a minimum number of users (in percentage) for any given period, to break the association rule, i.e. 75% of the users should break the {milk, bread}->{egg} association rule.

The first threshold limit and the second threshold limit may be used for detecting at least one of quality or quantity issues for the one or more items.

In addition, the determiner module 215 may determine the average and the association from the current transaction details and corresponding average and association from the past transaction details for a same user. For instance, from the past user purchase behavior for all the user's details may be used to determine user buying patterns such as minimum quantity, and association rules. For example, (a) a first user always buys a minimum 2 kg of tomato in 90% of his past visits to the store, (b) a second user always buys a minimum 1.5 kg of tomato in 95% of his past visits to the store and (c) a third user always buys {milk, bread and eggs} together in the past 75% of her visits to the store.

The comparator module 217 may compare the at least one of the average from the current transaction details with the first threshold limit and the association from the current transaction details with a second threshold limit. The comparator module 217 may receive the first threshold limit and the second threshold limit from the determiner module 215. To compare the first threshold limit and the second threshold limit, the comparator module 217 may receive an average quantity for each item from all the current transaction details for the set period. For example, output may be average purchase quantity for tomato as 0.5 kg, 0.9 kg for apple, etc. Prior to performing a comparison, the comparator module 217 may calculate the percentage of users who bought less than or equal to the average quantity of item. For example, 70% of the user bought 0.45 kg of tomato. The comparator module 217 may compare if the percentage of user who bought less than or equal to the average item quantity, crosses the minimum number of users (in percentage) in the given period (i.e. set period), to buy less the minimum threshold quantity (i.e. the first threshold limit) of an item. For example, 70% of the customers bought 0.45 kg of tomato would cross the 60% threshold limit set by the store according to some embodiments. This outcome may be sent to the detector module 219 by the comparator module 217.

The comparator module 217 may compare the association rule across all the current transaction details in the current period (i.e. set period) with the second threshold limit. The second threshold limit may be the number of association rule violation allowed in the current period. Prior to performing comparison, the comparator module 217 may calculate association rule violations for all possible association rules in the current period. For example, {milk, bread}->{missing egg}, may indicate a violation of 50% across all orders in the current period. Furthermore, the comparator module 217 may calculate the percentage of customers who violated possible associate rule. For example, 60% of the customers violated the association rule {milk, bread}-{egg}. The comparator module 217 may compare if the percentage of customers who violated an association rule, crosses the minimum number of users (in percentage) in the given period, to break the association rule. For example, 60% of the customers violated the association rule {milk, bread}->{egg} does not cross the 75% threshold limit set by the store. This outcome may be sent to the detector module 219 by the comparator module 217.

The detector module 219 may detect at least one of quality and quantity issues for the one or more items based on the comparison. The detector module 219 may receive the outcome of the comparison with the first threshold limit and the second threshold limit from the comparator module 217. Based on the comparison, the detector module 219 detects at least one of quality or quantity issues. For instance, the detector module 219 detects a quality issue when the average of each of the item is less than the first threshold limit. That is, if a quality of the item is not good, users may decide to pick from among a few available good ones from a pile. Similarly, the detector module 219 detects a quantity issue when the association is less than the second threshold limit with one or more items in the association. For example, with the association rule {milk, bread}->{egg}, if it is observed that users are buying only milk and bread and not eggs, this may be indicative that there are no eggs in the shelf. This is confirmed by the outcome of comparing the average and the association with corresponding average and association from the past transaction details for same user. For example, if 75% of the past transaction details of users have bought the missing items in 90% of the time, then it means at a given period (i.e., for the set period) that the store is unable to sell an item.

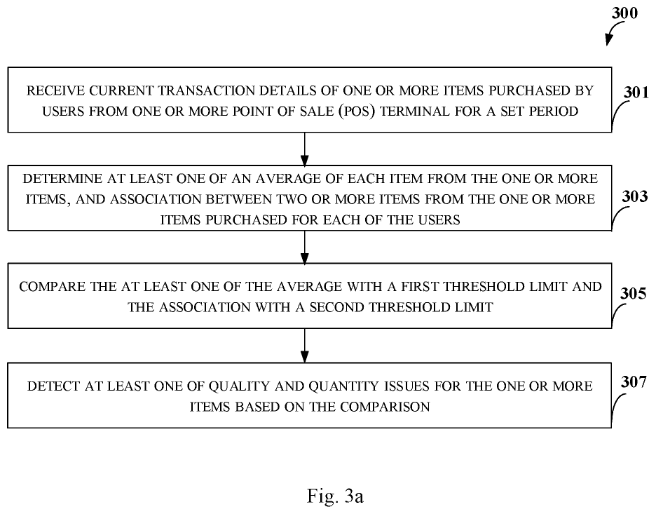

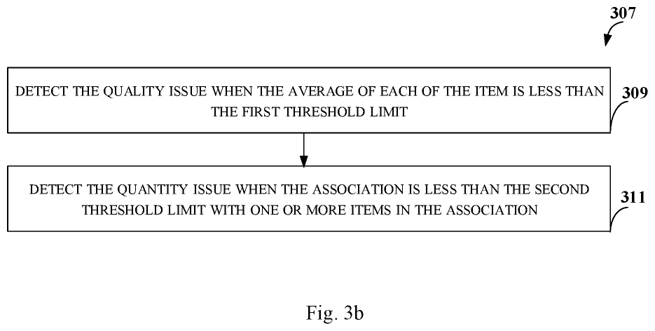

FIG. 3a-FIG. 3b illustrates a flowchart showing a method for real-time causation analysis for detecting item quality and quantity issues in accordance with some embodiments of present disclosure.

As illustrated in FIG. 3a-FIG. 3b, the method 300 includes one or more blocks for real-time causation analysis. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement methods according to one or more embodiments. Additionally, individual blocks may be deleted from the methods without departing from the scope of the subject matter described herein. Furthermore, the method can be implemented in any suitable hardware, software, firmware, or combination thereof.

At block 301, the receiver module 213 may receive current transaction details of one or more items purchased by users from one or more Point of Sale (POS) terminal for a set period. The set period may be one of a period based on time and a period based on count of the one or more items.

At block 303, the determiner module 215 may determine at least one of an average of each item from the one or more items, and association between two or more items from the one or more items purchased for each of the users.

At block 305, the comparator module 217 may compare the at least one of the average with a first threshold limit and the association with a second threshold limit. The first threshold limit and the second threshold limit may be set by calculating an average of each item and an association between two or more items, respectively, from past transaction details for a same set period.

At block 307, the detector module 219 may detect at least one of quality or quantity issues for the one or more items based on the comparison.

FIG. 3b illustrates an exemplary representation of the detection of quality and quantity issues in accordance with some embodiments of present disclosure.

At block 309, the detector module 219 may detect the quality issue when the average of each of the item is less than the first threshold limit.

At block 311, the detector module 219 may detect the quantity issue when the association is less than the second threshold limit with one or more items in the association.

Some of the advantages of the present disclosure are listed below.

The present disclosure provides real-time analysis to detect item quality issues, thereby, preventing or reducing the risk of health accidents from occurring, which may be caused by poor or deteriorated item quality.

The present disclosure provides real-time analysis to detect item quantity issues, thereby, avoiding a situation in which an item becomes scarce.

### Computing System

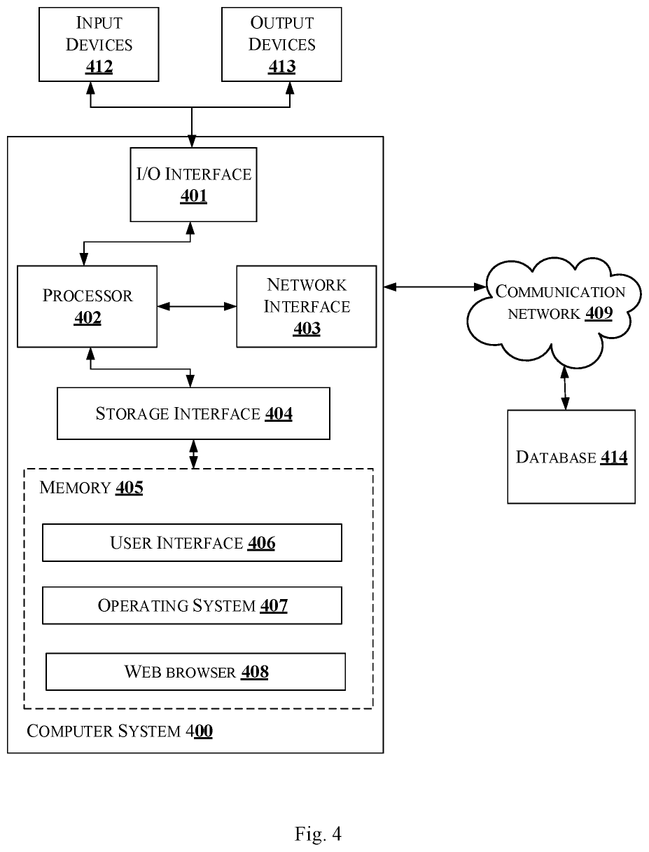

FIG. 4 illustrates a block diagram of an exemplary computer system 400 for implementing embodiments consistent with the present disclosure. In at least one embodiment, the computer system 400 may be used to implement the causation analysis system 107. The computer system 400 may include a central processing unit (“CPU” or “processor”) 402. The processor 402 may include at least one data processor for real-time causation analysis for detecting item quality and quantity issues. The processor 402 may include specialized processing units such as integrated system (bus) controllers, memory management control units (controllers), floating point units, graphics processing units (graphics processors), digital signal processing units (signal processors), etc. or combinations thereof.

The processor 402 may be disposed in communication with one or more input/output (I/O) devices (not shown) via I/O interface 401. The I/O interface 401 employ communication protocols/methods such as, without limitation, audio, analog, digital, monoaural, Radio Corporation of America (RCA) connector, stereo, IEEE®-1394 high speed serial bus, serial bus, Universal Serial Bus (USB), infrared, Personal System/2 (PS/2) port, Bayonet Neill-Concelman (BNC) connector, coaxial, component, composite, Digital Visual Interface (DVI), High-Definition Multimedia Interface (HDMI®), Radio Frequency (RF) antennas, S-Video, Video Graphics Array (VGA), IEEE® 802.11b/g/n/x, Bluetooth, cellular e.g., Code-Division Multiple Access (CDMA), High-Speed Packet Access (HSPA+), Global System for Mobile communications (GSM®), Long-Term Evolution (LTE®), Worldwide interoperability for Microwave access (WiMax®), or the like.

Using the I/O interface 401, the computer system 400 may communicate with one or more I/O devices such as input devices 412 and output devices 413. For example, the input devices 412 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 413 may be a printer, fax machine, video display (e.g., Cathode Ray Tube (CRT), Liquid Crystal Display (LCD), Light-Emitting Diode (LED), plasma, Plasma Display Panel (PDP), Organic Light-Emitting Diode display (OLED) or the like), audio speaker, etc.

In some embodiments, the computer system 400 includes the causation analysis system 107. The processor 402 may be disposed in communication with the communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x, etc. The communication network 409 may include, without limitation, a direct interconnection, Local Area Network (LAN), Wide Area Network (WAN), a wireless network (e.g., using Wireless Application Protocol), the Internet, etc. Using the network interface 403 and the communication network 409, the computer system 400 may communicate with a database 414. The network interface 403 may employ connection protocols include, but not limited to, direct connect, Ethernet (e.g., twisted pair 10/100/1000 Base T), Transmission Control Protocol/Internet Protocol (TCP/IP), token ring, IEEE® 802.11a/b/g/n/x, etc.

The communication network 409 includes, but is not limited to, a direct interconnection, a Peer to Peer (P2P) network, Local Area Network (LAN), Wide Area Network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE®-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407, etc. In some embodiments, computer system 400 may store user/application data, such as, the data, variables, records, etc., as described in this disclosure. Such databases may be implemented as fault-tolerant, relational, scalable, secure databases such as Oracle or Sybase.

The operating system 407 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® IOS®, GOOGLE™ ANDROID™, BLACKBERRY® OS, or the like.

In some embodiments, the computer system 400 may implement web browser 408 stored program components. Web browser 408 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, ADOBE® FLASH®, JAVASCRIPT®, JAVA®, Application Programming Interfaces (APIs), etc. The computer system 400 may implement a mail server (not shown in FIG. 4) stored program component. The mail server may be an Internet mail server such as Microsoft Exchange, or the like. The mail server may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. The computer system 400 may implement a mail client (not shown in FIG. 4) stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

The terms “an embodiment”, “embodiment”, “embodiments”, “the embodiment”, “the embodiments”, “one or more embodiments”, “some embodiments”, and “one embodiment” mean “one or more (but not all) embodiments of the disclosure” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

The illustrated operations of FIGS. 3a and 3b show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit (e.g., processor) or by distributed processing units.

Finally, the language used in the specification has been principally selected for readability and instructional purposes, and it may not have been selected to delineate or circumscribe the inventive subject matter. It is therefore intended that the scope of the present disclosure be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference number | Description |
|---|---|
| 100 | Environment |
| 101₁, 101₂. . . 101_{N} | Point of Sale (POS) terminal |
| 103 | Database |
| 105 | Communication network |
| 107 | Causation Analysis System |
| 111 | I/O interface |
| 113 | Memory |
| 115 | Processor |
| 200 | Data |
| 201 | Current transaction data |
| 203 | Other data |
| 211 | Modules |
| 213 | Receiver module |
| 215 | Determiner module |
| 217 | Comparator module |
| 219 | Detector module |
| 221 | Other module |
| 400 | Computer system |
| 401 | I/O interface |
| 402 | Processor |
| 403 | Network interface |
| 404 | Storage interface |
| 405 | Memory |
| 406 | User interface |
| 407 | Operating system |
| 408 | Web browser |
| 409 | Communication network |
| 412 | Input devices |
| 413 | Output devices |
| 414 | Database |

What is claimed is:

1. A method for real-time causation analysis for detecting item quality and/or quantity issues, the method comprising:
receiving, by a causation analysis system, current transaction details of one or more items purchased by at least one user from one or more Point of Sale (POS) terminals for a set period;
determining, by the causation analysis system, at least one of an average of each item from the one or more items or an association between two or more items from the one or more items purchased;
comparing, by the causation analysis system, the at least one of the average with a first threshold limit or the association with a second threshold limit; and
detecting, by the causation analysis system, at least one of a quality issue or a quantity issue for the one or more items based on the comparison.

2. The method of claim 1, wherein the set period is one of a period based on time and a period based on a count of the one or more items.

3. The method of claim 1, further comprising setting the first threshold limit and the second threshold limit by calculating an average of each item and an association between two or more items, respectively, from past transaction details for a same set period.

4. The method of claim 1, wherein detecting the quality and quantity issues further comprises:
detecting, by the causation analysis system, a quality issue when an average of each of the item is less than the first threshold limit; and
detecting, by the causation analysis system, a quantity issue when the association is less than the second threshold limit with one or more items in the association.

5. The method of claim 1, further comprising:
comparing, by the causation analysis system, the average and the association with a corresponding average and association from past transaction details for the at least one user.

6. The method of claim 1, further comprising determining, by the causation analysis system, at least one of an average of each item from the one or more items and an association between two or more items from the one or more items purchased for a plurality of users.

7. The method of claim 6, further comprising comparing, by the causation analysis system, the average and the association with a corresponding average and association from past transaction details for the plurality of users.

8. A causation analysis system for real-time causation analysis for detecting item quality and quantity issues, the system comprising:
a processor; and
a memory communicatively coupled to the processor, wherein the memory stores processor-executable instructions, which, when executed, cause the processor to:
receive current transaction details of one or more items purchased by at least one user from one or more Point of Sale (POS) terminals for a set period;
determine at least one of an average of each item from the one or more items or an association between two or more items from the one or more items purchased;
compare the at least one of the average with a first threshold limit and the association with a second threshold limit; and
detect at least one of a quality issue or a quantity issue for the one or more items based on the comparison.

9. The causation analysis system of claim 8, wherein the set period is one of a period based on time and a period based on count of the one or more items.

10. The causation analysis system of claim 8, wherein the processor is further configured to set the first threshold limit and the second threshold limit by calculating an average of each item and an association between two or more items, respectively, from past transaction details for a same set period.

11. The causation analysis system of claim 8, wherein the processor is further structured to:
detect a quality issue when the average of each of the item is less than the first threshold limit; and
detect a quantity issue when the association is less than the second threshold limit with one or more items in the association.

12. The causation analysis system of claim 8, wherein the processor is further structured to:
compare the average and the association with a corresponding average and an association from the past transaction details for the at least one user.

13. The causation analysis system of claim 8, wherein the processor is further configured to determine at least one of an average of each item from the one or more items and an association between two or more items from the one or more items purchased for a plurality of users.

14. The causation analysis system of claim 13, wherein the processor is further structured to compare the average and the association with corresponding average and association from the past transaction details for the plurality of users.

15. A non-transitory computer readable medium including instructions stored thereon which, when executed by at least one processor, cause a causation analysis system to perform operations comprising:
receiving current transaction details of one or more items purchased by users from one or more Point of Sale (POS) terminals for a set period;
determining at least one of an average of each item from the one or more items or an association between two or more items from the one or more items purchased;
comparing the at least one of the average with a first threshold limit and the association with a second threshold limit; and
detecting at least one of a quality issue or a quantity issue for the one or more items based on the comparison.
